(19) United States
(12) Patent Application Publication
(10) Pub. No.: US 2008/0135603 A1
(43) Pub. Date: Jun. 12, 2008

(54) Method for Soldering a Heat Exchanger, and a Heat Exchanger Produced According to this Method

(75) Inventors: Wolfgang Geiger, Ludwigsburg (DE); Karl-Heinz Staffa, Stuttgart (DE)

Correspondence Address: FOLEY AND LARDNER LLP;SUITE 500, 3000 K STREET NW, WASHINGTON, DC, 20007, US

(73) Assignee: BEHR GmbH & Co. KG, Stuttgart (DE)

(21) Appl. No.: 11/572,866

(22) PCT Filed: Jul. 4, 2005
(86) PCT No.: PCT/EP05/07181

§ 371 Date: Nov. 2, 2007

(30) Foreign Application Priority Data
Jul. 30, 2004 (DE) 10 2004 037 392.2

(51) Int. Cl. B23K 1/00

(52) U.S. Cl. 228/183

(57) ABSTRACT

The invention relates to a method for soldering an all-aluminum heat exchanger, particularly a coolant radiator (1) for motor vehicles with a collecting reservoir (2) inside of which an additional heat exchanger (4), particularly a transmission oil cooler is placed. The invention also relates to a heat exchanger produced according to this method. The invention provides that the additinal heat exchanger (4) is, according to the so-called Nocolok® method, firstly soldered separately in a vacuum before being soldered together with the all-aluminum heat exchanger (1). The additional heat exchanger (4) is attached to the collecting reservoir (2) only via connecting sleeves (5) and soldered nuts (7).

The invention relates to a method for soldering an all-aluminum heat exchanger, particularly a coolant radiator for motor vehicles according to the preamble of patent claim 1, and to a heat exchanger produced according to this method according to the preamble of patent claim 4.

Transmission oil coolers for motor vehicles are often housed in a coolant reservoir of a coolant radiator and are hence cooled by the coolant of the cooling circuit for the internal combustion engine of the motor vehicle. Transmission oil coolers are known as brazed disc-type or flat tubular radiators whose connecting sleeves are inserted through corresponding openings in the wall of the coolant reservoir and sealed. Where the coolant reservoirs are made of plastic, the sealing is effected by means of O-rings, as known from the applicant's EP-A 866 300 or DE-A 101 06 510. This type of sealing and screwing requires additional assembly time and involves a risk of leaks.

For recycling reasons, pedigree heat exchangers, e.g. brazed all-aluminum heat exchangers, are produced today that are soldered using the so-called Nocolok method, known from the applicant's DE-A 26 14 872 or DE-A 195 48 244. This soldering method allows relatively large soldering gaps to be bridged and leaves no residues of corrosive flux. There are reservations, however, about using the Nocolok soldering method on heat exchangers for which a high internal cleanliness is demanded, such as e.g. on transmission oil coolers for motor vehicles. For this reason transmission oil coolers are preferably soldered with a flux-free soldering method under vacuum and then placed into the aluminum coolant reservoir and sealed with O-rings.

EP-A 846 931 describes an all-aluminum heat exchanger in the form of a coolant radiator with a coolant reservoir in which an all-aluminum oil cooler is installed and soldered. The oil cooler is designed as a dual-tube oil cooler, is retained by two ring-shaped flanges and attached or fixed to the wall of the coolant reservoir. Both heat exchangers are soldered in a single work process, i.e. using the same soldering method. One disadvantage of this production method is that a relatively large number of parts, combined with the corresponding installation work, are necessary for the fixing of the oil cooler proper and in relation to the coolant reservoir of the radiator.

The object of the present invention is to provide a method for soldering an all-aluminum heat exchanger with additional heat exchanger permitting cost-efficient production and a high internal cleanliness of the additional heat exchanger. A further object of the invention is to create an all-aluminum heat exchanger with additional heat exchanger having the necessary preconditions for soldering using the Nocolok method.

This object is first achieved by the feature of patent claim 1. The invention provides for the following three consecutive process steps: First, i.e. in a first soldering process, the additional heat exchanger is soldered flux-free under vacuum; then the soldered additional heat exchanger is placed into the collecting reservoir of the all-aluminum heat exchanger and fixed there for a subsequent, second soldering; finally the two heat exchangers, i.e. the already soldered additional heat exchanger and the not yet soldered heat exchanger are soldered together using the so-called Nocolok method, whereby the additional heat exchanger is subjected to a second soldering process.

The method according to the invention offers on the one hand the advantage that the additional heat exchanger, particularly a transmission oil cooler for a motor vehicle, can be produced with high internal cleanliness with no flux residues. The transmission oil cooler or the additional heat exchanger can hence be produced cost-efficiently in a simple soldering device, i.e. with simple clamping means. The soldered additional heat exchanger can subsequently be fixed in the collecting reservoir of the heat exchanger using simple means, i.e. the individual parts of the additional heat exchangers no longer have to be clamped; this also eliminates a large number of parts that would otherwise be necessary for the clamping, and the corresponding set-up time. The Nocolok soldering method produces a leak-tight soldered connected between additional heat exchanger and collecting reservoir so that any kind of sealants are eliminated. Nocolok soldering is performed at a temperature that is lower than the melting temperature of the soldered connections of the additional heat exchanger already soldered—this is due to the fact that the solder was melted by vacuum soldering and has partially diffused into the base material and that parallel to this, base material has mixed with the solder so that a microstructure with a melting temperature lying above the soldering temperature, i.e. the melting temperature of the solder alloy, has been created in the area of the soldered seam. This effect is attributable to the fact that the eutectic solder has a higher Si content than the non-eutectic microstructure forming in the area of the soldered joint during soldering. Silicon reduces the melting point. As a result of the diffusion of silicon into the base material, the Si content drops and hence the melting point is increased. The already vacuum-soldered additional heat exchanger is therefore not melted again or impaired in its soldered joint during the subsequent Nocolok soldering.

In an advantageous embodiment of the invention, the remelting temperature of the soldered joint of the additional heat exchanger can be influenced by certain soldering parameters during the first soldering process, namely by the soldering time, soldering temperature, the soldering gap and the volume of solder between the parts to be soldered. The advantage is thus obtained that the distance to the remelting temperature of the additional heat exchanger is sufficiently large by comparison with the soldering temperature during the second soldering process, so that a remelting or the creation of a possible leak in the additional heat exchanger is reliably avoided during the second soldering process.

The object of the invention is also achieved by the features of patent claim 4. According to the invention, an additional heat exchanger is provided with two connecting sleeves that are inserted through corresponding openings in the wall of the collecting reservoir and secured from the outside by a solderable nut. This allows the advantage to be achieved that the additional heat exchanger already soldered under vacuum is sufficiently fixed to the collecting reservoir for the subsequent Nocolok soldering process so that a leak-tight soldering of the two connecting sleeves is possible. Additional heat exchanger and heat exchanger can thus be completely soldered in one working process. Instead of laborious clamping means known from the prior art, according to the invention only two so-called soldered nuts are required, i.e. solder-clad nuts that on the one hand ensure the fixing and on the other hand the leak-tight soldering of the sleeves.

According to an advantageous embodiment of the invention, the parts of the additional heat exchanger to be soldered together, for example the flat tubes and turbulence inserts, are made of an aluminum alloy with the standardized designation EN-AW 3003 for the base material and a solder cladding of an aluminum-silicon alloy with the standardized designation EN-AW 4004.

In a further advantageous embodiment of the invention, the collecting reservoir of the heat exchanger is made of an aluminum alloy with the standardized designation EN-AW 3003 and a solder cladding of an Al—Si alloy with the standardized designations EN-AW 4045, EN-AW 4047 or EN-AW 4343. This material combination for the additional heat exchanger on the one hand, and for the heat exchanger on the other hand offers the advantage that the soldering temperature of the Nocolok soldering process is sufficiently far below the melting temperature of the soldered additional heat exchanger. The additional heat exchanger thus suffers no impairment to its strength and microstructure formation as a result of the subsequent Nocolok soldering process.

One exemplary embodiment of the invention is shown in the drawing and is described in greater detail below.

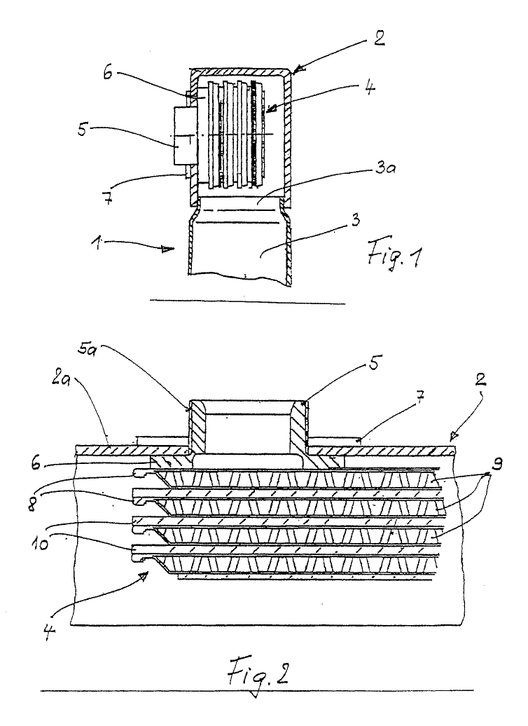

FIG. 1 shows a cross section through a coolant reservoir with installed transmission oil cooler, and

FIG. 2 shows a longitudinal section through the coolant reservoir with a detail of the transmission oil cooler.

FIG. 1 shows an all-aluminum heat exchanger designed as a coolant radiator 1 for an internal combustion engine of a motor vehicle (not illustrated). The coolant radiator 1 is shown only partially, i.e. with a coolant reservoir 2 made from a U-shaped sheet metal profile that on its open side receives tube ends 3a of flat tubes 3. Coolant of a coolant circuit for the internal combustion engine (not illustrated) flows through the coolant reservoir 2 and the flat tubes 3. An all-aluminum heat exchanger 1 of this kind is known, for example, from the applicant's DE-A 195 43 986. Inside the cross section of the coolant reservoir 2 is an additional heat exchanger designed as a transmission oil cooler 4 that is also made completely of aluminum as a flat tubular oil cooler. The transmission oil cooler 4 has two connecting sleeves of which one connecting sleeve 5 is shown that passes through an opening in the collecting reservoir 2 and protrudes to the outside. The transmission oil cooler 4 also has a flange 6 that rests against the inside of the coolant reservoir 2. Screwed over the connecting sleeve 5 protruding to the outside is a soldered nut 7 made of a solder-clad aluminum plate. Transmission oil flows through the transmission oil cooler 4 on the primary side, i.e. through the flat tubes, said cooler being cooled on the secondary side by the coolant of the coolant radiator 1.

FIG. 2 shows the coolant reservoir 2 and the trans-mission oil cooler 4 in a partial longitudinal section, i.e. in the area of the connecting sleeve 5. The transmission oil cooler 4 is made up of a number of flat tubes 8 within which turbulence inserts 9 are arranged. Arranged between the flat tubes 8 are spacers, studs or turbulence plates 10 through which coolant flows. On the other hand, transmission oil flows through the turbulence inserts 9. The inside of the flat tubes 8 that are linked in the known manner but not illustrated, is connected via the connecting sleeve 5 with flange 6 to the outside to a transmission oil circuit (not illustrated). The connecting sleeve 5 has an outside thread 5a onto which the soldered nut 7 with its corresponding inside thread is screwed. The coolant reservoir 2 has, at least in the area of the connecting sleeve 5, a flat wall 2a against the inside of which the flat formed flange 6 rests that continues outwards in the connecting sleeve 5 and is thus formed in one piece with the latter. The flange 6 and hence the transmission oil cooler 4 are fastened against the wall 2a by the soldered nut 7 and the outside thread 5a.

The method according to the invention takes place as follows: First the transmission oil cooler 4 consisting of the individual parts such as connecting sleeve 5 with flange 6, flat tubes 8, turbulence inserts 9 and turbulence plates 10 is prepared for vacuum soldering, clamped, fixed and soldered in a vacuum furnace (not illustrated). The individual parts, e.g. the flat tubes 8 designed as welded flat tubes, have a solder cladding on both sides that permits on the one hand soldering with the turbulence inserts 9 and on the other hand soldering with the turbulence plates 10 arranged on the outside and with the flange 6. After vacuum soldering, the transmission oil cooler 4 is finished, i.e. fully functional. In the next process step, the coolant radiator 1 with all the individual parts such as tubes 3 and coolant reservoirs 2 and ribs (not illustrated) are prepared for soldering. In the process, the trans-mission oil cooler 4 already soldered under vacuum is placed into the coolant reservoir 2, its sleeve 5 is through a corresponding opening in the wall 2a and is secured from the outside by the soldered nut 7. The second connecting sleeve of the transmission oil cooler 4 (not illustrated) is fastened in the same way to the wall 2a of the coolant reservoir 2. The transmission oil cooler 4 is hence—without additional clamping means—fixed in the coolant reservoir 2 only with the nut 7. Final soldering is then performed during which the coolant radiator 1 is placed into a soldering furnace (not illustrated) with the transmission oil cooler 4 where it is soldered using the so-called Nocolok soldering method that is known, for example, from DE-A 26 14 872 mentioned at the beginning. The soldered nut 7 that is solder clad on the side facing towards the wall 2a is soldered to the wall 2a, as is the flange 6 to the inside of the wall 2a.

The Nocolok soldering and the vacuum soldering are performed at roughly the same or similar soldering temperatures, whereby the soldered joints of the Nocolok soldering and no longer softened or melted.

On completion of Nocolok soldering, the transmission oil cooler 4 is connected firmly and leak-tight to the coolant reservoir 2 via its connecting sleeves. Further sealing means, such as e.g. O-rings, are not required. The connection to the oil circuit (not illustrated) is made by means of screw fittings (not illustrated).

1. A method for soldering an all-aluminum heat exchanger, particularly a coolant radiator for motor vehicles, with a collecting reservoir in which an additional heat exchangers, particularly a transmission oil cooler is arranged, wherein
the additional heat exchanger is soldered separately in a first soldering process using a flux-free soldering method, in particular in a vacuum and then has a remelting temperature,
is subsequently positioned and fixed in the collecting reservoir of the heat exchanger, and
in a second soldering process is soldered together with the all-aluminum heat exchanger including collecting reservoir using the so-called Nocolok method, whereby the soldering temperature lies below the remelting temperature of the soldered additional heat exchanger.

2. The method as claimed in claim 1, wherein the remelting temperature of the additional heat exchanger, particularly of its soldered joints, is set during the first soldering process by soldering parameters such as soldering time, soldering temperature, soldering gap width and solder volume in such a way that the distance to the soldering temperature of the second soldering process is sufficiently large.

3. The method as claimed in claim 1, wherein for the first and for the second soldering process, solders with roughly the same melting temperature range are used.

4. A heat exchanger, produced according to the method as claimed in claim 1, wherein the additional heat exchanger has two connecting sleeves protruding outwards with outside thread and the collecting reservoir has openings to receive the connecting sleeves and that the additional heat exchanger is held and sealed against the collecting reservoir by means of solderable solder-clad nuts screwed onto the outside thread.

5. The heat exchanger as claimed in claim 4, wherein the additional heat exchanger has solderable individual parts, in particular flat tubes and turbulence inserts that can be made from an aluminum alloy with the standardized designation EN-AW 3xxx (3003) or EN-AW 6xxx (6060) for the base material with a solder cladding of an Al—Si alloy with the standardized designation EN-AW 4xxx (4004).

6. The heat exchanger as claimed in claim 4, wherein the collecting reservoir can be made from an aluminum alloy with the standardized designation EN-AW 3xxx (EN-AW 3003) and from a solder cladding of an Al—Si alloy with the standardized designation EN-AW 4xxx (EN-AW 4045).
